(19) United States
(12) Patent Application Publication
(10) Pub. No.: US 2021/0224751 A1
(43) Pub. Date: Jul. 22, 2021

(54) SYSTEM AND METHOD FOR GENERATING AN IMMERSIVE CANDIDATE STORYBOARD

(71) Applicant: KEBOLI INC., Sammamish, WA (US)

(72) Inventors: Sivakumaar NAGALINGAM, Seattle, WA (US); Sathyanarayanan HARIHARAN, Sammamish, WA (US)

(73) Assignee: KEBOLI INC., Sammamish, WA (US)

(21) Appl. No.: 17/152,228

(22) Filed: Jan. 19, 2021

(30) Foreign Application Priority Data
Jan. 16, 2020 (IN) 201941046776

(51) Int. Cl. G06Q 10/10; G06F 9/451; G06N 20/00; G10L 15/26; G06F 40/279; G10L 15/22

(52) U.S. Cl. CPC G06Q 10/1053; G06F 9/451; G10L 15/22; G10L 15/26; G06F 40/279; G06N 20/00

(57) ABSTRACT

A method includes screening, by a cognitive engine, resumes of a plurality of candidates to shortlist a set of candidates from the plurality of candidates. The method further includes recording, by a recording module, an interview of at least one candidate of the shortlisted set of candidates. Furthermore, the method includes receiving, by the cognitive engine, a recorded interview file of the at least one candidate of the shortlisted set of candidates. The method additionally includes processing, by the cognitive engine, the recorded interview file of the at least one candidate of the shortlisted set of candidates to generate an interview summary including transcribed content, a plurality of bookmarks, and a plurality of keywords associated with the recorded interview file. Additionally, the method includes generating, by the cognitive engine, an immersive candidate storyboard including a resume summary and the interview summary of the at least one candidate.

### FIELD OF THE DISCLOSURE

The present disclosure generally relates to immersive candidate storyboard, and more specifically, relates to a system and a method for generating an immersive candidate storyboard of the candidate for recruitment process.

### BACKGROUND OF THE DISCLOSURE

A typical process of recruitment by an organization (for example, a recruiter) involves screening a plurality of resumes for shortlisting candidates, conducting interviews with the shortlisted candidates, and hiring a suitable candidate from the interviewed shortlisted candidates based on the outcome of the interviews. Typically, one or more online tools may be used for screening resumes of the candidates.

An interview involves conversation between one or more interviewers and an interviewee. The conversation can happen either face-to-face or via an online platform between one or more interviewers and interviewee. After conducting an interview, an interviewer may assign a score to a candidate and then provide a candidate feedback including the assigned score. Interviewer can select a candidate based on domain expertise, experience level, interview scores, other technology skills, certifications, and the like.

In practice, whenever the existing online tools are used by the recruiters for shortlisting purpose, the recruiters are restricted to static information that is available from conventional online tools. Similarly, when hiring managers review candidates resume that are shortlisted and interviewed, the hiring managers can only see details about a candidate shared by interviewers. The hiring managers do not get to know the details of the interview or the work experience of the candidate. The conventional online tools do not have the capability of providing a comprehensive candidate storyboard of the candidates. Hence, making a very informed hiring decision becomes a very difficult process.

### SUMMARY OF THE DISCLOSURE

In accordance with one exemplary embodiment of the present disclosure, a method for generating an immersive candidate storyboard, using a processor-based system, for a recruitment process of a job position is disclosed. The method includes screening, by a cognitive engine, resumes of a plurality of candidates to shortlist a set of candidates from the plurality of candidates. The method further includes recording, by a recording module, an interview of at least one candidate of the shortlisted set of candidates. Furthermore, the method includes receiving, by the cognitive engine, a recorded interview file of the at least one candidate of the shortlisted set of candidates. The method additionally includes processing, by the cognitive engine, the recorded interview file of the at least one candidate of the shortlisted set of candidates to generate an interview summary including transcribed content, a plurality of bookmarks, and a plurality of keywords associated with the recorded interview file. The transcribed content, the plurality of bookmarks, and the plurality of keywords are configured to provide access to a corresponding snippet of the recorded interview file. Additionally, the method includes generating, by the cognitive engine, the immersive candidate storyboard including a resume summary and the interview summary of the at least one candidate of the shortlisted set of candidates. The method also includes displaying, by an input-output interface, the immersive candidate storyboard.

In accordance with another embodiment of the present disclosure, a system for generating an immersive candidate storyboard for a recruitment process of a job position is disclosed. The system includes a memory having computer-readable instructions stored therein and a processor configured to execute the computer-readable instructions to enable a cognitive engine to screen resumes of a plurality of candidates to shortlist a set of candidates from the plurality of candidates and a recording module to record an interview of at least one candidate of the shortlisted set of candidates. The cognitive engine is configured to receive a recorded interview file of the at least one candidate of the shortlisted set of candidates and process the recorded interview file of the at least one candidate of the shortlisted set of candidates to generate an interview summary including transcribed content, a plurality of bookmarks, and a plurality of keywords associated with the recorded interview file. The transcribed content, the plurality of bookmarks, and the plurality of keywords are configured to provide access to a corresponding snippet of the recorded interview file. The cognitive engine is further configured to generate the immersive candidate storyboard including a resume summary and the interview summary of the at least one candidate of the shortlisted set of candidates. The cognitive engine is also configured to an input-output interface to display the immersive candidate storyboard.

### BRIEF DESCRIPTION OF THE FIGURES

These and other features, aspects, and advantages of the exemplary embodiments can be better understood when the following detailed description is read with reference to the accompanying drawings in which like characters represent like parts throughout the drawings, wherein:

FIG. 1 illustrates a block diagram of a system for generating an immersive candidate storyboard in accordance with an embodiment of the present disclosure;

FIG. 2 illustrates a block diagram of an immersive candidate storyboard generated by the system of FIG. 1 in accordance with an embodiment of the present disclosure;

FIG. 3 illustrates a schematic representation screen illustrating a screenshot of transcribed content of a recorded audio interview in accordance with an embodiment of FIG. 1 of the present disclosure;

FIG. 4 illustrates a schematic representation screen illustrating a screenshot of a plurality of keywords extracted from transcribed content of a recorded audio interview in accordance with an embodiment of FIG. 1 of the present disclosure;

FIG. 5 is a schematic representation screen illustrating a screenshot of a plurality of bookmarks extracted from transcribed content of a recorded audio interview in accordance with an embodiment of FIG. 1 of the present disclosure;

FIG. 6 is a flow chart illustrating a method for generating an immersive candidate storyboard in accordance with an embodiment of the present disclosure;

FIG. 7 is a block diagram indicative of the I/O interface, back end processes, and storage database in accordance with an embodiment of the present disclosure;

FIG. 8 is a block diagram of a high-level specific architecture of the system for generating the immersive candidate storyboard in accordance with an embodiment of FIG. 1 of the present disclosure;

FIG. 9 illustrates a schematic representation screen illustrating a screenshot of a recruiter dashboard in accordance with an embodiment of FIG. 1 of the present disclosure;

FIG. 10 illustrates a schematic representation screen illustrating a screenshot of an interviewer dashboard in accordance with an embodiment of FIG. 1 of the present disclosure;

FIG. 11 illustrates a schematic representation screen illustrating a screenshot of an accounts manager dashboard in accordance with an embodiment of FIG. 1 of the present disclosure;

FIG. 12 illustrates a block diagram representative of a hiring process performed by a user, using the system in accordance with an embodiment of the present disclosure.

Further, skilled artisans will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having the benefit of the description herein.

### DETAILED DESCRIPTION OF THE INVENTION

For the purpose of promoting an understanding of the principles of the invention, reference will now be made to the embodiments illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

The terms “comprise”, “comprising”, or any other variations thereof, are intended to cover a non-exclusive inclusion such that a process or method that comprises a list of steps does not comprise only those steps but may comprise other steps not expressly listed or inherent to such a process or a method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

In addition to the illustrative aspects, exemplary embodiments, and features described above, further aspects, exemplary embodiments of the present disclosure will become apparent by reference to the drawings and the following detailed description.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible.

In one embodiment, a method for generating an immersive candidate storyboard, using a processor-based system, for a recruitment process of a job position is disclosed. The method includes screening, by a cognitive engine, resumes of a plurality of candidates to shortlist a set of candidates from the plurality of candidates. The method further includes recording, by a recording module, an interview of at least one candidate of the shortlisted set of candidates. The method further includes receiving, by the cognitive engine, a recorded interview file of the at least one candidate of the shortlisted set of candidates. The method also includes processing, by the cognitive engine, the recorded interview file of the at least one candidate of the shortlisted set of candidates to generate an interview summary including transcribed content, a plurality of bookmarks, and a plurality of keywords associated with the recorded interview file. The transcribed content, the plurality of bookmarks, and the plurality of keywords are configured to provide access to a corresponding snippet of the recorded interview file. Additionally, the method includes generating, by the cognitive engine, the immersive candidate storyboard including a resume summary and the interview summary of the at least one candidate of the shortlisted set of candidates. The method further includes displaying, by an input-output interface, the immersive candidate storyboard.

In another embodiment of the disclosure, a processor-based system for generating an immersive candidate storyboard, i.e., digital candidate story board is disclosed. Further, in accordance with the embodiments of the present disclosure, the exemplary system and method enable the recorded interviews to be played or reviewed by another user/person (for example, a hiring manager, director, and the like) of an organization at any point of time. In addition, the exemplary system and method enable the user/person to view information related to the history of the candidates, bookmarked relevant portions of interviews, search for keywords associated with the interviews, the recorded interview transcripts, and view feedbacks and associated ratings provided by the one or more interviewers. The interview transcripts, bookmarked portions of the interviews, keywords associated with the interviews enable to access corresponding snippets of the interview. In accordance with the embodiments discussed herein, the candidate storyboard is an immersive, searchable, and dynamic storyboard of the candidate.

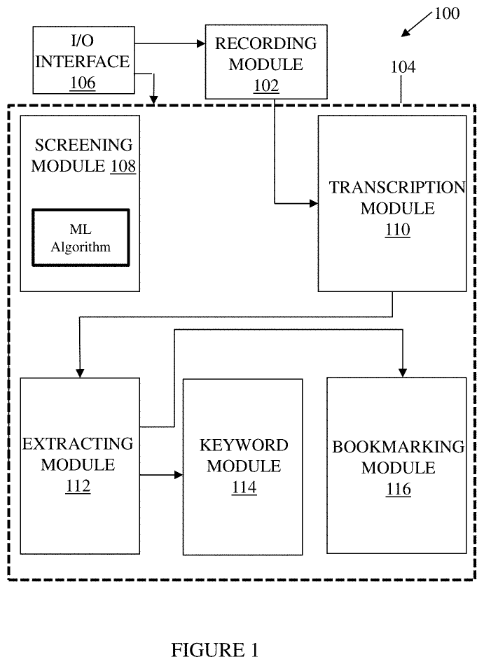

FIG. 1 illustrates a block diagram of a system 100 for generating an immersive candidate storyboard in accordance with an embodiment of the present disclosure. In the illustrated embodiment, the system 100 is a processor-based system configured to generating an immersive candidate storyboard for a recruitment process of a job position. The system 100 includes a recording module 102, a cognitive engine 104, and an input-output (I/O) interface 106. The cognitive engine 104 includes a screening module 108, a transcription module 110, an extracting module 112, a keyword module 114, and a bookmarking module 116.

In one embodiment, the system 100 may include at least one processor and a memory (not shown). The at least one processor include as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions stored in the memory.

The memory may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

The I/O interface 106 may include a variety of software and hardware interfaces, for example, a web interface, a user interface, a graphical user interface, and the like. The I/O interface 106 may enable the system 100 to communicate with other computing devices, such as web servers and external data servers (not shown). The I/O interface 106 may facilitate multiple communications within a wide variety of networks and protocol types, including wired networks, for example, LAN, cable, etc., and wireless networks, such as WLAN, cellular, or satellite. The I/O interface 106 may include one or more ports for connecting a number of devices to one another or to another server. In the illustrated embodiment, the I/O interface 106 is communicatively coupled to the recording module 102 and the cognitive engine 104.

As mentioned earlier, the cognitive engine 104 includes the screening module 108, the transcription module 110, the extracting module 112, the keyword module 114, and the bookmarking module 116. In one embodiment of the present disclosure, the screening module 102 is configured for screening resumes of a plurality of candidates for shortlisting a set of suitable candidates for a job position. The resumes may be obtained from but not limited to established third party providers and job portals. In one embodiment, the screening module 102 screens the resumes of the plurality of candidates using a Machine Learning (ML) algorithm and provides information about experience and domain expertise of the shortlisted set of candidates. The screening module 102 screens the resumes based on but not limited to candidate's technology skills, technical experience, maturity and experience tenure, commitment and duration in projects, professional growth with reference to title and expertise, certifications, and other information of record. The screening process may be automated to match suitable set of candidates to skills that are required for a job description. In some embodiments, the screening module 102 may also screen the resumes of the candidates based on social relevancy of the candidates. The social relevancy of the candidates, for example, may include but not limited to engagement in public sites, publishing articles/blogs, publishing software code repositories or contributing to software code repositories, or the like. In one embodiment, the screening module 102 includes a ML model that will screen the resumes of candidates and identifies the predefined areas and intelligently ranks the resumes.

In the same embodiment of the present disclosure, after the screening of the resumes of the plurality of candidates by the screening module 108, a recruiter schedules interviews for the suitable shortlisted candidates. It should be noted herein that the term “recruiter” refers to a person who is responsible for screening the shortlisted candidates and maintaining the entire workflow starting from the shortlisting step to the final decision-making process of the shortlisted candidates. The interviews, for example, may be an audio interview or a video interview. In one embodiment, an interview may further include but not limited to a software coding interview, a technical domain interview, and a soft skill and culture fit interview for each shortlisted candidate. The type of interviews and the number of interviews may vary depending on the application. The recording module 102 is configured to record each interview of each shortlisted candidate. In one embodiment, the recording module 102 has an audio unit configured to perform recording of an audio interview of each shortlisted candidate. In another embodiment, the recording module 102 has a camera unit configured to perform a video interview of each shortlisted candidate. In one embodiment, the recording module 102 is communicatively coupled to the transcription module 110 and configured to receive a recorded interview file associated with each shortlisted candidate generated by recording module 102. The transcription module 110 is configured to process the recorded interview file and transcribe interview content. Further, it should be noted herein that the transcribed content includes conversation between an interviewer and an interviewee. The term “interviewer” refers to a person conducting the interview and the term “interviewee” refers to a person/candidate undergoing the interview. Further, the extracting module 112 is communicatively coupled to the transcription module 110 and configured to extract text from the transcribed content with reference to time stamps. The extracted text would be identified and denoted with reference to the interviewer and interviewee. The I/O interface 106 is configured to display the extracted text from the transcribed content with reference to time stamps. Further, the I/O interface 106 enables a user to click on any transcribed sentence to automatically access a corresponding snippet of the recorded interview file.

Furthermore, in the same embodiment, the keyword module 114 is communicatively coupled to the extracting module 112 and configured to automatically generate relevant keywords associated with the interview from the extracted text. In some embodiments, the keywords may be generated based on predefined rules associated with the application. In some embodiments, the keywords may be generated based on predefined rules associated with the application. In certain other applications, user inputs associated with keywords may be manually input by a user based on associated application via the I/O interface 106. Further, the I/O interface 106 enables a user to click on any keywords to automatically access a corresponding snippet of the recorded interview file. When a user clicks on any generated relevant keyword, the user is directed to a particular portion/snippet of the interview where the conversation happened between the interviewer and the interviewee.

Also, in the same embodiment of the present disclosure, the bookmarking module 116 is communicatively coupled to the extracting module 112 and configured to bookmark one or more portions associated with the interview from the extracted text. The one or more portions of the interview may refer to but not limited to the one or more portions of the interview where the interviewer is asking new questions or something specifically related (for example, any topic, information, and the like) to a point of view of the interview. In some embodiments, the bookmarks may be generated based on predefined rules associated with the application. In certain other applications, user inputs associated with bookmarks may be manually input by a user based on associated application via the I/O interface 106. Further, the I/O interface 106 enables a user to click on any bookmark to automatically access a corresponding snippet of the recorded interview file. When a user clicks on any generated any bookmark, the user is directed to a particular portion of the interview where the conversation happened between the interviewer and the interviewee. In one embodiment, the cognitive engine 104 may be configured to highlight at least one bookmark from the plurality of bookmarks, using highlighting signs. The highlighting signs may include but not limited to indicating by a star mark, bold markings, or the like. The highlighting of bookmarks may be done by the cognitive engine 104 based on predefined rules and may be indicative of certain important snippets of the conducted interview.

It should be noted herein the recorded interview that are transcripted and extracted as text can be available to any relevant person (for example, hiring managers, director, and the like) of an organization for viewing at any point of time. The immersive candidate storyboard includes all the information related to the candidate. Herein, the information of the candidate includes but not limited to skill set, years of experience, expected salary, location preference, type of work, domain skills interview, soft skills interview, rating of the domain skills, soft skills, and the like.

The exemplary system can be used by recruiters and interviewers to function as free-lancers and build their brand value. In one embodiment, the cognitive engine 104 can generate an immersive candidate storyboard also showing rating of recruiters for parameters such as but not limited to ability of the recruiter to source a particular technology candidate, success rate of a recruiter in a location, success rate of a recruiter in a particular technology, success rate of a recruiter in a domain (industry), and success rate of a recruiter in closure rate (i.e. the speed of closing a position). In one embodiment, the cognitive engine 104 can generate an immersive candidate storyboard also showing rating of interviewers for parameters such as but not limited to interviewer style, interviewer technology knowledge, interviewer feedback writing, and success rate of candidates for a particular interviewer. These ratings can be utilized to reward and attract freelance recruiters and interviewers. The exemplary system can be used by recruiters and interviewers to advertise and demand a premium for their services for interviewing candidates, offer coaching sessions or classes to prospective candidates, and to recommend and refer candidates.

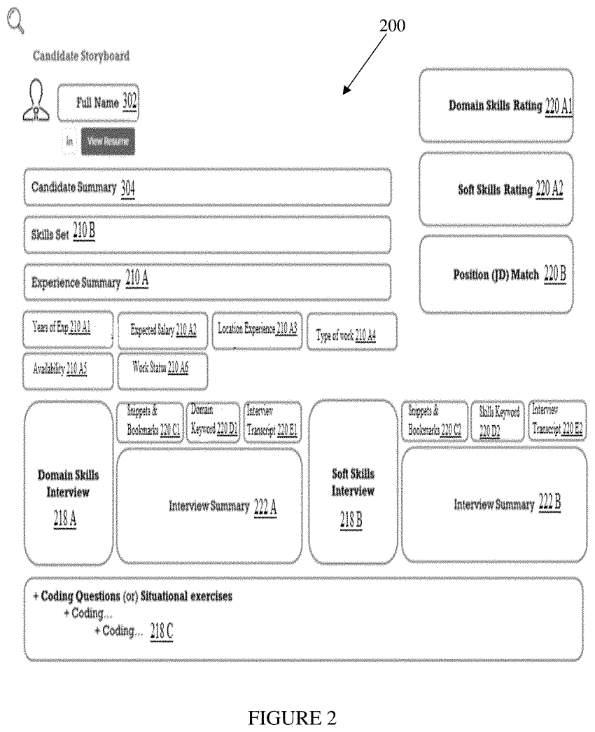

FIG. 2 illustrates a block diagram of an immersive candidate storyboard 200 generated by the system 100 of FIG. 1 in accordance with an embodiment of the present disclosure. The immersive candidate storyboard 200 includes details (or history) of a candidate, for example, including but not limited to resume summary including a candidate name 302, a candidate summary 304, experience summary 210A, years of experience 210A1, expected salary 210A2, location preference 210A3, type of work 210A4, availability time frame 210A5, eligibility to work status 210A6, and skills set 210B. The immersive candidate storyboard 200 further includes interview summary including domain skills interview recording file 218A, snippets and bookmarks 220C1 associated with the domain skills interview, domain keywords 220D1 associated with the domain skills interview, interview transcript/transcribed content 220E1 associated with the domain skills interview, and interviewer summary 222A associated with the domain skills interview. The interview summary further includes soft skills interview file 218B, snippets and bookmarks 220C2 associated with the soft skills interview, soft skill keywords 220D2 associated with the soft skills interview, interview transcript/transcribed content 220E2 associated with the soft skills interview, interviewer summary 222B associated with the soft skills interview, and domain skills rating 220A1. The interview summary additionally includes soft skills rating 220A2, position match rating 220B, and exercise information 218C, for example, software coding exercise information done by a candidate.

In one aspect of the present disclosure, the domain skills rating 220A1 is done by an interviewer that tests a candidate on a specific technology domain or a specific business domain expertise. The interviewer may provide sub-ratings for the interview questions and then provide a consolidated rating based on the sub-ratings. Similarly, the soft skills rating 220A2 is also by an interviewer that tests a candidate on situational awareness and soft skills questions.

Further, a position match rating 220B is generated based on the various aspects such as skills, bookmarks, experience level, keywords, and match as per requirements of the job description. In one embodiment, the position match rating is presented as a percentage with reference to a particular job description. In certain embodiments, the matching parameters may be displayed with reference to position match rating.

Furthermore, in the same embodiment, domain skills interview recording file 218A can be played and viewed by a user such as a recruiter, an interviewer, an accounts manager, or a hiring manager. It should be noted herein that the term “accounts manager” may refer to a person involved in curation and presentation of shortlisted candidates for a recruitment process of a job position to a hiring manager/prospective employer.

As noted earlier, an interview which is done with a candidate is recorded by the recording module 102 and fed into the cognitive engine 104. A user such as a hiring manager is able to view recorded interview file, bookmarked portions of the recorded interview file, matching keywords, transcripts/transcribed content, and the like. It should be noted herein that the immersive candidate story board 200 all the information discussed herein pertaining to a particular candidate. The candidate information discussed herein is not all inclusive and should not be construed as a limitation of the scope of the disclosure. In one embodiment, the immersive candidate storyboard (200) of the at least one candidate from the shortlisted set of candidates is generated in a blind mode without disclosing personal details of the at least one candidate.

The exemplary system can be used as a platform for providing qualified, vetted technical talent for prospective employers. The exemplary system facilitates to find highly skilled and qualified talent with the right domain and technology expertise to successfully build solutions for hiring managers/organizations. Hiring companies will also be able to use the exemplary system as a service and integrate the process and software platform for hiring the right candidates/contractors. The exemplary system can be used to follow a process/methodology that would enable hiring managers to make their decisions regarding qualified candidates very quickly and proceed to hiring them.

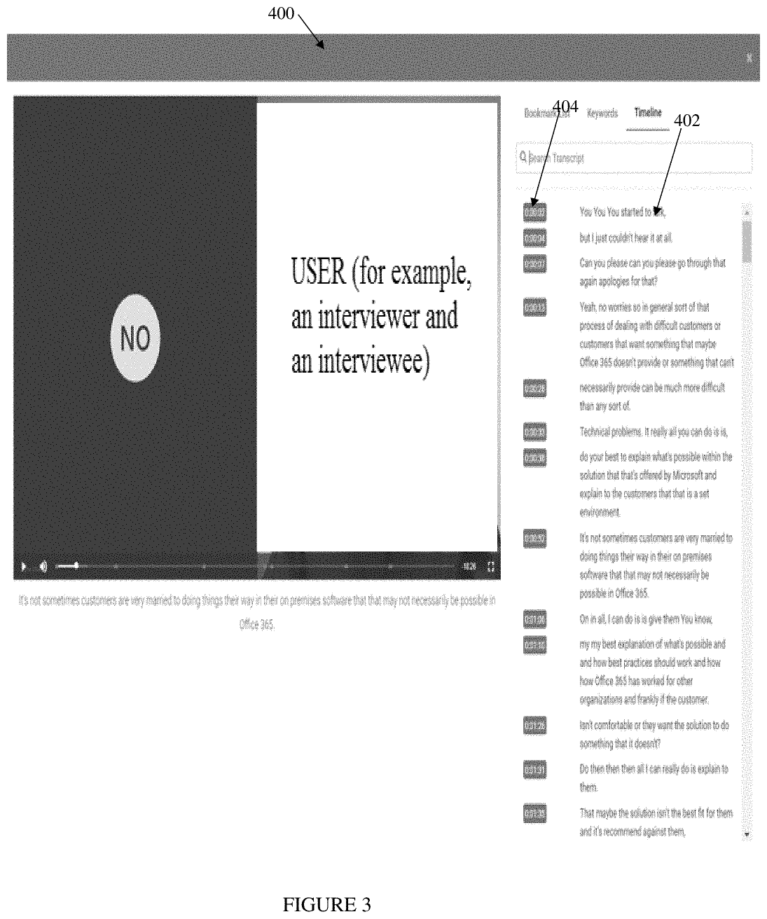

FIG. 3 illustrates a schematic representation screen illustrating a screenshot 400 of transcribed content of a recorded audio interview in accordance with an embodiment of FIG. 1 of the present disclosure. As mentioned earlier, the recording module 102 is configured to record each interview of each shortlisted candidate. The transcription module 110 is configured to receive a recorded interview file associated with each shortlisted candidate generated by recording module 102. The transcription module 110 is configured to process the recorded interview file and generate transcribed content. The extracting module 112 is configured to extract text 402 from the transcribed content with reference to time stamps 404. The I/O interface 106 is configured to display the extracted text 402 from the transcribed content with reference to time stamps 404.

It should be noted herein that a conversation between an interviewer and an interviewee during an interview is recorded and presented with reference to timestamps. Further, the I/O interface 106 enables a user to click on any transcribed sentence to automatically access a corresponding snippet of the recorded interview file. The recorded snippets can be selectively played by a user as per the time stamps. It should be noted herein that although audio interview is discussed herein, the exemplary system is also applicable for a video interview.

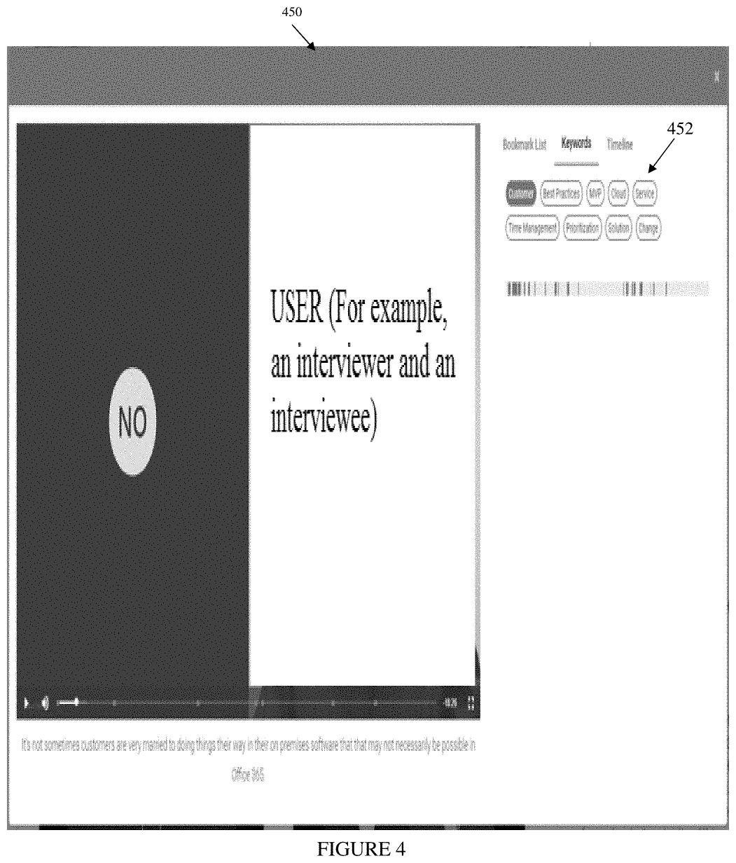

FIG. 4 illustrates a schematic representation screen illustrating a screenshot 450 of a plurality of keywords extracted from transcribed content of a recorded audio interview in accordance with an embodiment of FIG. 1 of the present disclosure. As mentioned earlier, the keyword module 114 is configured to automatically generate relevant domain keywords 452 associated with the interview from the extracted text. In some embodiments, the domain keywords 452 may be generated based on predefined rules associated with the application. In some embodiments, the domain keywords 452 may be generated based on predefined rules associated with the application. In certain other applications, user inputs associated with the domain keywords 452 may be manually input by a user based on associated application via the I/O interface 106. Further, the I/O interface 106 enables a user to click on any domain keyword to automatically access a corresponding snippet of the recorded interview file. When a user clicks on any generated relevant domain keyword, the user is directed to a particular portion/snippet of the interview where a corresponding conversation happened between the interviewer and the interviewee. It should be noted herein that although audio interview is discussed herein, the exemplary system is also applicable for a video interview.

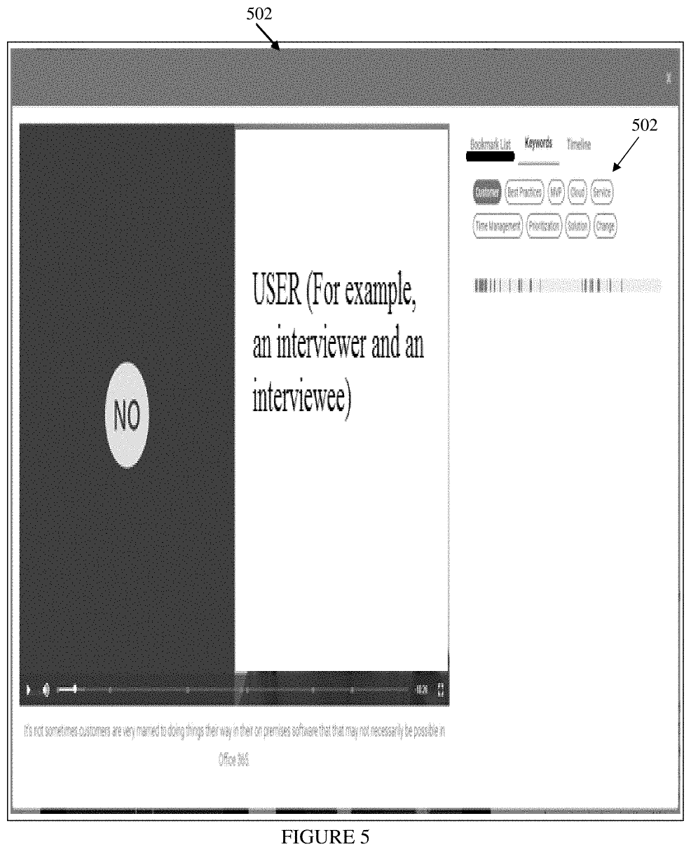

FIG. 5 is a schematic representation screen illustrating a screenshot 500 of a plurality of bookmarks 502 extracted from transcribed content of a recorded audio interview in accordance with an embodiment of FIG. 1 of the present disclosure. As mentioned earlier, the bookmarking module 116 is configured to bookmark one or more portions associated with the interview from the extracted text. The one or more portions of the interview may refer to but not limited to the one or more portions of the interview where the interviewer is asking new questions or something specifically related (for example, any topic, information, and the like) to a point of view of the interview. In some embodiments, the bookmarks 502 may be generated based on predefined rules associated with the application. In certain other applications, user inputs associated with bookmarks 502 may be manually input by a user based on associated application via the I/O interface 106. Further, the I/O interface 106 enables a user to click on any bookmark to automatically access a corresponding portion/snippet of the recorded interview file. When a user clicks on any generated bookmark, the user is directed to a particular portion/snippet of the interview where the conversation happened between the interviewer and the interviewee.

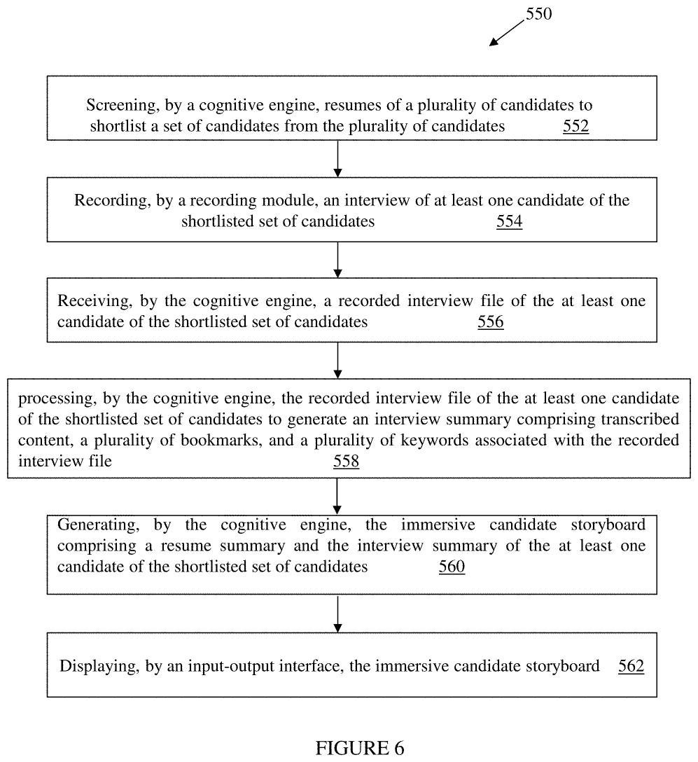

FIG. 6 is a flow chart illustrating a method 550 for generating an immersive candidate storyboard in accordance with an embodiment of the present disclosure.

At step 552, resumes of a plurality of candidates is screened by the screening module of a cognitive engine using a ML algorithm for shortlisting a set of suitable candidates. The shortlisted candidates are informed via an email communication for appearing in an interview. The interview may be an audio interview and/or a video interview. In one embodiment, the screening module 102 screens the resumes of the plurality of candidates and provides information about experience and domain expertise of the shortlisted set of candidates. The screening module 102 screens the resumes based on but not limited to candidate's technology skills, technical experience, maturity and experience tenure, commitment and duration in projects, professional growth with reference to title and expertise, certifications, and other information of record. The screening process may be automated to match suitable set of candidates to skills that are required for a job description. In some embodiments, the screening module 102 may also screen the resumes of the candidates based on social relevancy of the candidates. The social relevancy of the candidates, for example, may include but not limited to engagement in public sites, publishing articles/blogs, publishing software code repositories or contributing to software code repositories, or the like.

At step 554, recording of an interview of at least one candidate of the shortlisted set of candidates is performed by the recording module. The interviews, for example, may be an audio interview or a video interview. In one embodiment, an interview may further include but not limited to a software coding interview, a technical domain interview, and a soft skill and culture fit interview for each shortlisted candidate. The type of interviews and the number of interviews may vary depending on the application. In one embodiment, the recording module 102 has an audio unit configured to perform recording of an audio interview of each shortlisted candidate. In another embodiment, the recording module 102 has a camera unit configured to perform a video interview of each shortlisted candidate. At step 556, a recorded interview file of the at least one candidate of the shortlisted set of candidates is received by the transcription module of the cognitive engine from the recording module.

At step 558, processing, by the cognitive engine, the recorded interview file of the at least one candidate of the shortlisted set of candidates is processed by the transcription module and extracting module of the cognitive engine to generate an interview summary including transcribed content, a plurality of bookmarks, and a plurality of keywords associated with the recorded interview file. Specifically, the transcription module processes the recorded interview file and transcribe interview content. The extracting module extracts text from the transcribed content with reference to time stamps.

Furthermore, in the same embodiment, the keyword module generates relevant keywords associated with the interview from the extracted text. In some embodiments, the keywords may be generated based on predefined rules associated with the application. In some embodiments, the keywords may be generated based on predefined rules associated with the application. In certain other applications, user inputs associated with keywords may be manually input by a user based on associated application via the I/O interface.

Also, in the same embodiment of the present disclosure, the bookmarking module bookmarks one or more portions associated with the interview from the extracted text. The one or more portions of the interview may refer to but not limited to the one or more portions of the interview where the interviewer is asking new questions or something specifically related (for example, any topic, information, and the like) to a point of view of the interview. In some embodiments, the bookmarks may be generated based on predefined rules associated with the application. In certain other applications, user inputs associated with bookmarks may be manually input by a user based on associated application via the I/O interface.

At step 560, the immersive candidate storyboard including a resume summary and the interview summary of the at least one candidate of the shortlisted set of candidates is generated by the cognitive engine. At step 562, the immersive candidate storyboard is displayed by the I/O interface. Specifically, the I/O interface displays the extracted text from the transcribed content with reference to time stamps. Further, the I/O interface enables a user to click on any transcribed sentence to automatically access a corresponding snippet of the recorded interview file. Further, the I/O interface enables a user to click on any keywords to automatically access a corresponding snippet of the recorded interview file. When a user clicks on any generated relevant keyword, the user is directed to a particular portion/snippet of the interview where the conversation happened between the interviewer and the interviewee. Furthermore, the I/O interface enables a user to click on any bookmark to automatically access a corresponding snippet of the recorded interview file. When a user clicks on any generated any bookmark, the user is directed to a particular portion of the interview where the conversation happened between the interviewer and the interviewee.

As noted earlier, whenever the conventional online tools are used by the recruiters for shortlisting purpose, the recruiters are restricted to static information that is available from conventional online tools. Similarly, when hiring managers review candidates resume that are shortlisted and interviewed, the hiring managers can only see details about a candidate shared by interviewers. The hiring managers do not get to know the details of the interview or the work experience of the candidate. In accordance with the embodiments discussed herein, when the exemplary system is used by the interviewers for shortlisting/selection purpose, the interviewers are able to bookmark a portion of the interview, for viewing in near future by the interviewer or by a third person (for example, hiring managers, director, and the like) of an organization involved in a recruitment process for a job position. The exemplary system has the capability of providing a comprehensive immersive candidate storyboard of the candidates. Hence, it becomes easy for a prospective employer to make a very informed hiring decision very quickly.

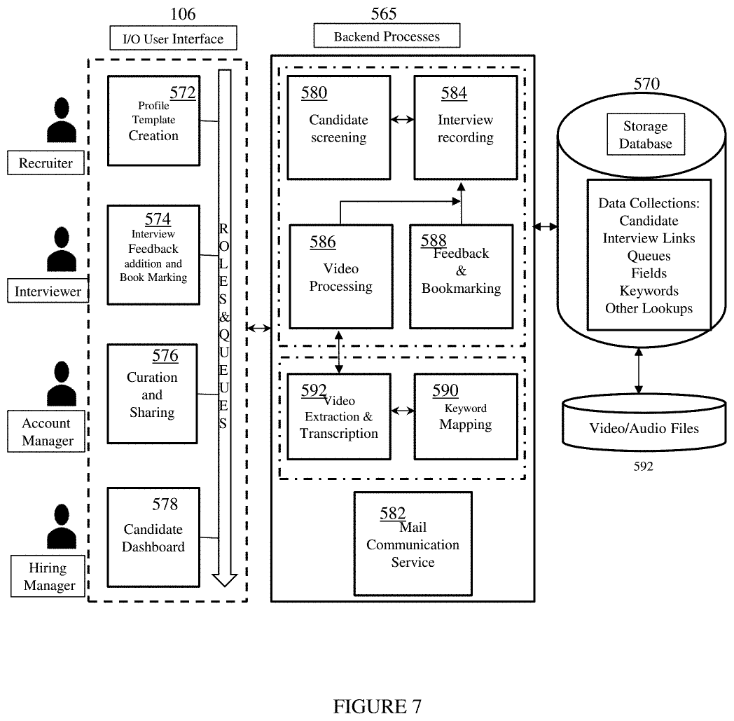

FIG. 7 is a block diagram indicative of the I/0 interface 106, back end processes 565, and storage database 570 of the exemplary system in accordance with an embodiment of the present disclosure. The hiring process involves steps done by a recruiter, an interviewer, an account manager, and a hiring manager using the exemplary system discussed herein. Herein, term “recruiter” refers to a person who is responsible for maintaining the entire workflow starting from profile creation, shortlisting step, screening step, ensure conducting of interview, obtaining feedback, and the final decision-making process of the shortlisted candidates 572.

The term “interviewer” refers to a person conducting the interview and the term “interviewee” refers to a person/candidate undergoing the interview. The interviewer is involved in viewing of screening step, performing the actual interview (both technical and soft skill), recording the interview, provide interview feedback, rating, and comments of the short-listed candidate 574. It should be noted herein that the term “accounts manager” may refer to a person involved in curation and presentation of shortlisted candidates for a recruitment process of a job position to a hiring manager/prospective employer 576. Specifically, the accounts manager is involved in reviewing list of selected candidates, viewing profile dashboards of selected candidates, assigned selected candidates for projects/campaign, track feedback of candidate profiles, sharing candidate list with prospective employers, review project list for candidate assignment, and the like. The hiring manager is involved in reviewing a digital immersive candidate storyboards generated pertaining to the short-listed candidates and making an informed decision whether the short-listed candidates can be hired 578.

The back end processes involve screening resumes of a plurality of by the screening module of a cognitive engine using a ML algorithm for shortlisting a set of suitable candidates 580. The shortlisted candidates are informed via an email communication for appearing in an interview 582. The interview may be an audio interview and/or a video interview. In one embodiment, the screening module screens the resumes of the plurality of candidates and provides information about experience and domain expertise of the shortlisted set of candidates. Further, recording of an interview of at least one candidate of the shortlisted set of candidates is performed by the recording module 584. Furthermore, a recorded interview file of the at least one candidate of the shortlisted set of candidates is received by the transcription module of the cognitive engine from the recording module. The recorded interview file of the at least one candidate of the shortlisted set of candidates is processed by the transcription module and extracting module of the cognitive engine 586 to generate an interview summary including transcribed content, a plurality of bookmarks 588, and a plurality of keywords 590 associated with the recorded interview file. Specifically, the transcription module processes the recorded interview file and transcribe interview content. The extracting module extracts text from the transcribed content with reference to time stamps 592. More specifically, the keyword module generates relevant keywords associated with the interview from the extracted text. Also, the bookmarking module bookmarks one or more portions associated with the interview from the extracted text. The immersive candidate storyboard including a resume summary and the interview summary of the at least one candidate of the shortlisted set of candidates is generated by the cognitive engine. on any bookmark to automatically access a corresponding snippet of the recorded interview file.

The storage database 570 may store data including but not limited to candidate interview information, candidate profiles, interview links, field/domain of hiring, generated keywords list, bookmarks list, and other lookup information. The storage database may be communicatively coupled to a repository 592 configured to store recorded interview files (i.e. audio/video files).

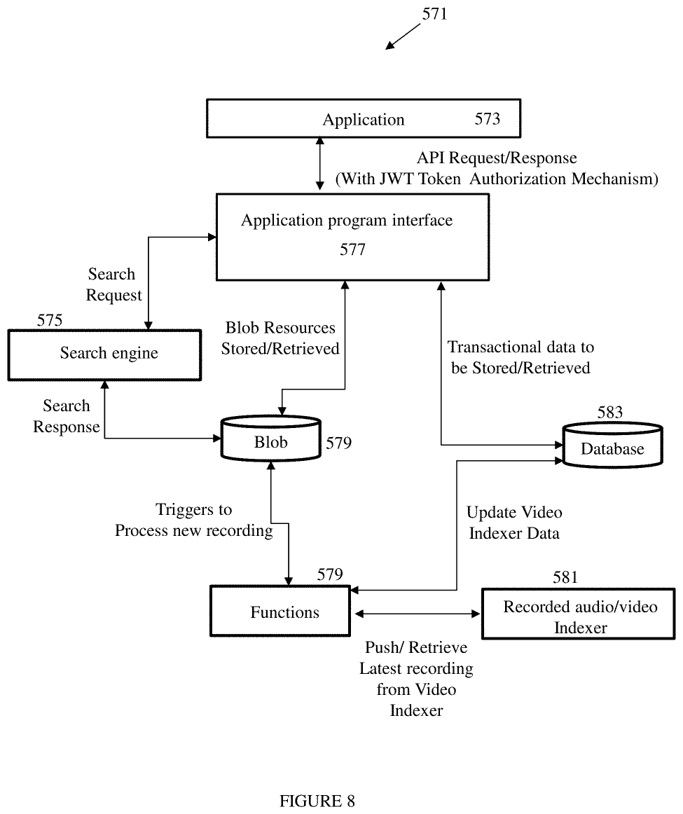

FIG. 8 is a block diagram of a high-level specific architecture 571 of the system 100 for generating the immersive candidate storyboard in accordance with an embodiment of FIG. 1 of the present disclosure. In the illustrated embodiment, the architecture 571 includes an application 573 which is configured to manage a web hosting service for building web applications. The application 573 is communicatively coupled to a search engine 575, for example, an azure search engine, via an application program interface 577. The search engine 575 is typically configured to perform either search query such as simple text search, Boolean search, or the like. The search engine 575 is configured to extract unstructured data such as images, audio, or other multimedia files from a binary large object (blob), for example, an azure blob. The search query can be used to trigger a process for new recording an interview using functions 579, for example, azure functions. Such functions can be used to push a new recording to a recording indexer or retrieve a new recording from a recording indexer 581. The indexed data (i.e. structured data) can be retrieved or stored in a database 583, for example, a cosmos database. The indexed data may include information related but not limited to the history of the candidates, bookmarked relevant portions of interviews, keywords associated with the interviews, the interview transcripts, and feedbacks and associated ratings provided by the one or more interviewers.

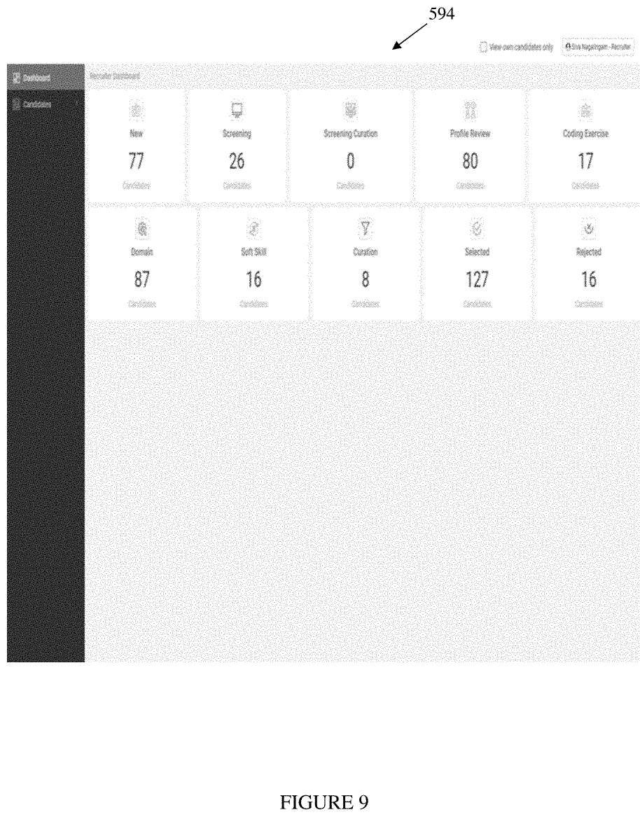

FIG. 9 illustrates a schematic representation screen illustrating a screenshot of a recruiter dashboard 594 in accordance with an embodiment of FIG. 1 of the present disclosure. The recruiter dashboard 594 includes information representative of the entire workflow including but not limited to profile creation, screening, curation, profile review, domain exercise, for example, software coding exercise, domain information, soft skill information, selected candidates, and rejected candidates. It should be noted herein that the system 100 is configured to restrict access permission of the recruiter dashboard 594 only to a corresponding person listed as a recruiter.

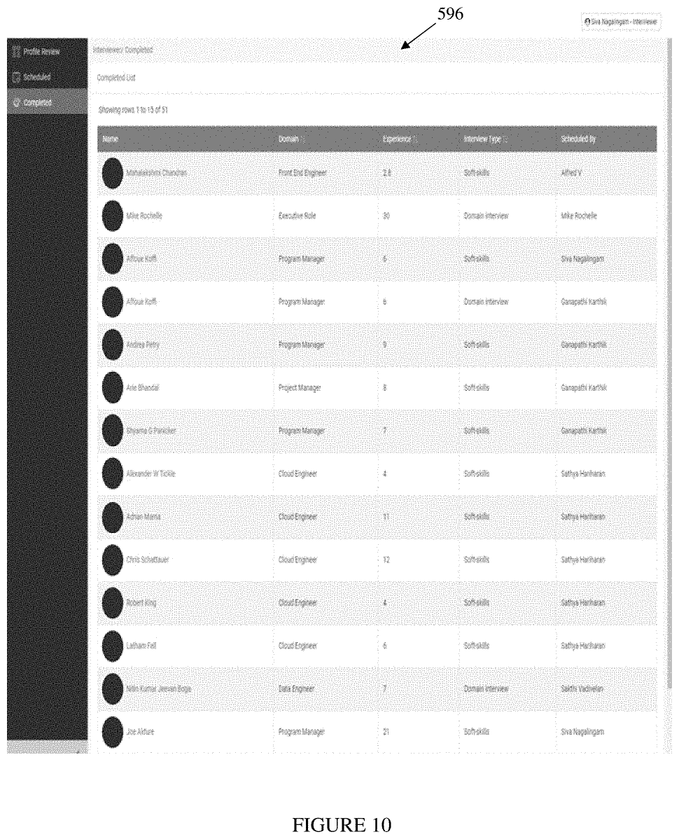

FIG. 10 illustrates a schematic representation screen illustrating a screenshot of an interviewer dashboard 596 in accordance with an embodiment of FIG. 1 of the present disclosure. The recruiter dashboard 596 includes information representative of but not limited to list of interview candidates, domain of each candidate, experience level of each candidate, type of interview, and scheduling person information. It should be noted herein that the system is configured to restrict access permission of the interview dashboard 596 only to a corresponding person listed as an interviewer.

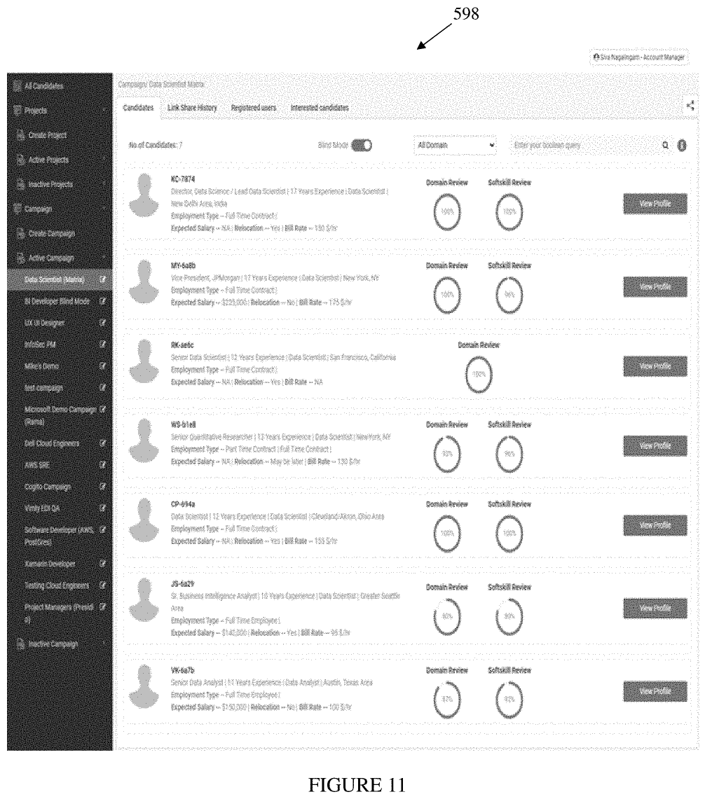

FIG. 11 illustrates a schematic representation screen illustrating a screenshot of an accounts manager dashboard 598 in accordance with an embodiment of FIG. 1 of the present disclosure. The accounts manager dashboard 598 information representative of but not limited to curation and presentation of shortlisted candidates for a recruitment process of a job position to a hiring manager/prospective employer. Specifically, the accounts manager dashboard 598 may include information associated with list of selected candidates, profile dashboards of selected candidates, assigned selected candidates for projects/campaign, track feedback of candidate profiles, candidate list for certain prospective employers, project list for candidate assignment, and the like.

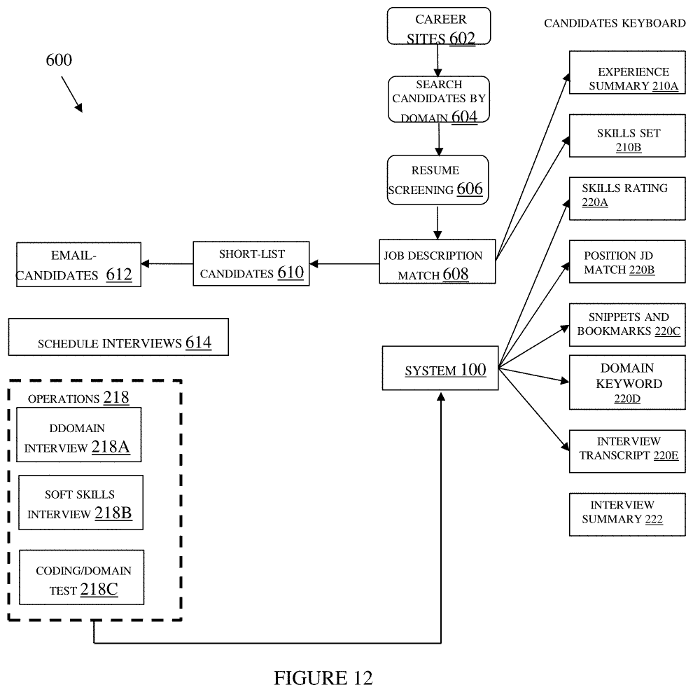

FIG. 12 illustrates a block diagram representative of a hiring process 600 by a user using the system 100 in accordance with an embodiment of FIG. 1 of the present disclosure. The hiring process 600 starts with identification of candidates by identifying resumes from career sites 602 (i.e. job portals). Specifically, the identification of the candidate resumes is performed by domain matching with candidate profile 604. Further, the resumes are screened 606 by matching the resumes with the mentioned job description 608. The resumes of the candidates are processed by the screening module using a ML algorithm. The screening module is used to screen the resumes based on candidate's experience and domain expertise. The screening module generates resume summary including but not limited to experience summary 210A, skills set 210B, and the like of the candidates. If the resumes match the mentioned job description, corresponding set of candidates are short-listed 610. The shortlisted candidates are informed for appearing in an interview, via an email communication 612. Further, the interview of each shortlisted candidate is scheduled by a recruiter or an interviewer 614.

Afterwards, an audio or a video interview of each shortlisted candidate is performed by the interviewer. The interview may include but not limited to a domain interview 218A, a soft skills interview 218B, and a coding/domain test 218C. In addition, the interviews are recorded by the recording module of the system. The system is used a user to provide ratings based on the skills set 210B of the candidates. Specifically, the system may be used by a user to provide ratings for the candidates based on the candidate's perceived proficiency in a technology or software coding style or knowledge or soft skill, for example. Further, the system may be used by a user to also provide information as to whether the skill sets 210B of the candidates' matches the requirement of a job description 220B. In addition, the system 100 also provides snippets and bookmarkings 220C for the recorded interviews, transcription of the recorded interviews 220D, and information on the keywords 220E for accessing corresponding snippets associated with the interview. Furthermore, the system 100 also provides a summary of the interviews 222 in a form of a feedback provided by the interviewer.

The exemplary system and associated method enable candidates the opportunity to freelance and work on projects, offer candidates as contracting resources for specific contracted time, offer candidates as permanent employee placement, offer candidates as contract to hire, offer a bidding engine for hiring organizations to compete on highly qualified candidates, enable to operate on a build, operate, and transfer model involving hiring top candidates, training them, get skilled work delivered by them, and then transfer the entire organization (i.e. group of candidates) to different technology firms.

It is to be noted that, although implementation of the present disclosure is not only limited to hiring purposes as disclosed herein but can be implemented in other areas where it would require selection through screening and interviewing process where an informed decision can be made regarding the selection based on a generated comprehensive immersive candidate storyboard.

We claim:

1. A method for generating an immersive candidate storyboard, using a processor-based system, for a recruitment process of a job position, the method comprising:
screening, by a cognitive engine, resumes of a plurality of candidates to shortlist a set of candidates from the plurality of candidates;
recording, by a recording module, an interview of at least one candidate of the shortlisted set of candidates;
receiving, by the cognitive engine, a recorded interview file of the at least one candidate of the shortlisted set of candidates;
processing, by the cognitive engine, the recorded interview file of the at least one candidate of the shortlisted set of candidates to generate an interview summary comprising transcribed content, a plurality of bookmarks, and a plurality of keywords associated with the recorded interview file, wherein the transcribed content, the plurality of bookmarks, and the plurality of keywords are configured to provide access to a corresponding snippet of the recorded interview file;
generating, by the cognitive engine, the immersive candidate storyboard comprising a resume summary and the interview summary of the at least one candidate of the shortlisted set of candidates; and
displaying, by an input-output interface, the immersive candidate storyboard.

2. The method as claimed in claim 1, wherein the screening, by the cognitive engine, the resumes of the plurality of candidates comprises screening the resumes using a machine learning algorithm.

3. The method as claimed in claim 1, wherein the interview is an audio interview.

4. The method as claimed in claim 1, wherein the interview is a video interview.

5. The method as claimed in claim 1, wherein the interview comprises a soft skill interview.

6. The method as claimed in claim 1, wherein the interview comprises a domain interview.

7. The method as claimed in claim 1, further comprising presenting, by the cognitive engine, the transcribed content with reference to a plurality of time stamps associated with the recorded interview file.

8. The method as claimed in claim 1, further comprising generating, by the cognitive engine, the plurality of keywords from the transcribed content.

9. The method as claimed in claim 1, further comprising highlighting, by the cognitive engine, at least one bookmark from the plurality of bookmarks.

10. The method as claimed in claim 1, further comprising receiving, by the cognitive engine, via the input-output interface, user inputs associated with the plurality of bookmarks and the keywords.

11. The method as claimed in claim 1, wherein generating, by the cognitive engine, the immersive candidate storyboard comprises generating the immersive candidate storyboard of the at least one candidate from the shortlisted set of candidates in a blind mode without disclosing personal details of the at least one candidate.

12. The method as claimed in claim 1, further comprising:
generating, by the cognitive engine, a recruiter dashboard of the plurality of the plurality of candidates, an interview dashboard of the shortlisted candidates, and an account manager dashboard of the shortlisted candidates; and
displaying, by the input-output interface, at least one of the recruiter dashboard, the interview dashboard, and the account manager dashboard.

13. A system for generating an immersive candidate storyboard for a recruitment process of a job position, the system comprising:
a memory having computer-readable instructions stored therein; and
a processor configured to execute the computer-readable instructions to enable:
a cognitive engine to screen resumes of a plurality of candidates to shortlist a set of candidates from the plurality of candidates;
a recording module to record an interview of at least one candidate of the shortlisted set of candidates;
wherein the cognitive engine is further configured to:
receive a recorded interview file of the at least one candidate of the shortlisted set of candidates;
process the recorded interview file of the at least one candidate of the shortlisted set of candidates to generate an interview summary comprising transcribed content, a plurality of bookmarks, and a plurality of keywords associated with the recorded interview file, wherein the transcribed content, the plurality of bookmarks, and the plurality of keywords are configured to provide access to a corresponding snippet of the recorded interview file; and
generate the immersive candidate storyboard comprising a resume summary and the interview summary of the at least one candidate of the shortlisted set of candidates; and
an input-output interface to display the immersive candidate storyboard.

14. The system as claimed in claim 13, wherein the cognitive engine is configured to screen the resumes using a machine learning algorithm.

15. The system as claimed in claim 13, wherein the interview is an audio interview.

16. The system as claimed in claim 13, wherein the interview is an audio interview.

17. The system as claimed in claim 13, wherein the cognitive engine is configured to present the transcribed content with reference to a plurality of time stamps associated with the recorded interview file.

18. The system as claimed in claim 13, wherein the cognitive engine is configured to generate the plurality of keywords from the transcribed content.

19. The system as claimed in claim 13, wherein the cognitive engine is configured to receive user inputs associated with the plurality of bookmarks and the keywords via the input-output interface.

20. The system as claimed in claim 13, wherein the cognitive engine is configured to generate the immersive candidate storyboard of the at least one candidate from the shortlisted set of candidates in a blind mode without disclosing personal details of the at least one candidate.

21. The system as claimed in claim 13, wherein the cognitive engine is configured to generate a recruiter dashboard of the plurality of the plurality of candidates, an interview dashboard of the shortlisted candidates, and an account manager dashboard of the shortlisted candidates; and
wherein the input-output interface is configured to display at least one of the recruiter dashboard, the interview dashboard, and the account manager dashboard.
